(19) United States
(12) Patent Application Publication
(10) Pub. No.: US 2002/0136485 A1
(43) Pub. Date: Sep. 26, 2002

(54) Apparatus and method for micro-electromechanical systems two-dimensional large movement electrostatic comb drive

(76) Inventors: Jason D. Reed, W. Hartford, CT (US); Kai Hu, Farmingdale, NJ (US); Robert F. Miracky, Cedar Park, TX (US); Claude Hilbert, Austin, TX (US)

Correspondence Address: David D. Bahler, FULBRIGHT & JAWORSKI L.L.P., SUITE 2400, 600 CONGRESS AVENUE, AUSTIN, TX, 78701, US

(21) Appl. No.: 09/776,166

(22) Filed: Feb. 2, 2001

(51) Int. Cl. G02B 6/35

(52) U.S. Cl. 385/18; 359/872

(57) ABSTRACT

An apparatus and method for a micro-electromechanical systems (MEMS) actuator such as a MEMS two-dimensional electrostatic comb drive having springs being advantageously configured to provide relatively large movements in first and second directions. In one embodiment, a comb drive apparatus includes a first set of comb pairs; a second set of comb pairs coupled to the first set of comb pairs; a stage coupled to the first and second sets of comb pairs; a first plurality of springs interposed between the second set of comb pairs and the stage and between the second set of comb pairs and the first set of comb pairs for movably coupling the second set of comb pairs to the stage and to the first set of comb pairs; and a second plurality of springs interposed between the first set of comb pairs and the stage and between the first set of comb pairs and the second set of comb pairs for movably coupling the first set of comb pairs to the stage and to the second set of comb pairs. In response to an appropriate electrostatic actuation force being applied to the MEMS two-dimensional electrostatic comb drive, the springs enable controlled displacement along both x-axis (horizontal direction) and y-axis (vertical direction).

### TECHNICAL FIELD OF THE INVENTION

The present invention relates to micro-electromechanical systems (MEMS) structures, in particular, to MEMS actuators such as MEMS comb drives.

### BACKGROUND OF THE INVENTION

Advancement of micro-electromechanical systems (MEMS) technology and general trends toward miniaturization of devices, structures, or subsystems could significantly benefit a variety of control or communication systems. Typically, MEMS structures employed in such control or communication systems include a MEMS actuator such as a MEMS comb drive to provide displacement functionality in diverse applications including, opto-electronic communication systems, and high-speed sensor systems. When MEMS actuators are integrated with optical devices, for example, micro-optical elements such as lenses, they may provide an efficient means for manipulating a received optical beam or signal. However, integration of such a MEMS actuator with a micro-optical element or sensor system may not meet the requirements for desired displacement functionality. In addition, by simply using suitable semiconductor, substrate, and/or conductive material layers to form a multilevel layered miniature structure, it can be difficult to provide robust and reliable MEMS actuators capable of large movements.

Often, deployment of MEMS actuators such as a MEMS comb drive, in an optical communication or sensor system, could allow fabrication of inexpensive and batch-fabricated integrated MEMS optical or MEMS sensor devices, respectively. Despite seemingly obvious advantages of such MEMS actuators for optical or sensor applications, systems and methods for forming these MEMS actuators that are required to meet increasingly demanding displacement functionality are desired.

A variety of MEMS actuators generally include a stage and one or more support members such as folded suspension members or spring bars, which are devised to suspend the stage. In a MEMS comb drive actuator, a typical stage may include one or more comb drive structures, each comb drive structure having interdigitated fingers to enable its operation responsive to an applied actuation.

In operation, actuation to a MEMS actuator such as a MEMS comb drive is oftentimes provided by an actuation force such as an electrostatic force being applied to either a selected comb drive structure or a particular set of comb drive structures for causing a desired displacement of the stage in a selected direction. For example, a suitable voltage bias may be applied to a first set of comb drive structures to result in the x-axis displacement of the stage in the horizontal direction.

Regardless of the type of a MEMS actuator employed, oftentimes a set of structural, electrical, and operational characteristics govern the functionality of a MEMS actuator based system and their potential applications. In general, structural and electrical characteristics such as response rates, design compactness, and/or power consumption can be utilized to characterize most MEMS actuators. For example, high response rates such as 100 μs or less, dimensions on the order of 1 mm or less, and/or power consumption typically less than 1 mW at maximum speed could be desirable for a particular application.

Operational characteristics such as suspension member deformation and a particular actuation scheme can also specify a MEMS actuator application domain. However, it could be difficult to build MEMS actuators including MEMS comb drive actuators that may provide relatively large displacements, for example, greater than 10 μm. Providing simultaneous displacements in multiple axes, for example, in two axes such as x-axis in horizontal direction and y-axis in vertical direction could be even more difficult. In addition, significantly high drive voltages in a particular range may be required for a controlled and precise operation of a MEMS actuator.

In general, it is difficult to completely avoid some deformation of support members due to suspension and actuation. For example, typically, an undesirable degree of deformation including bending, compression or extension occurs responsive to an applied actuation in support members such as spring bars or alike. To avoid any appreciable affect of these undesirable deformations of support members in a MEMS actuator based integrated device; it is desirable to devise the MEMS actuator with appropriate structural, electrical, and operational characteristics.

FIG. 1A is a top plan view of a prior art MEMS unidirectional comb drive 100. MEMS unidirectional comb drive 100 is useful in explaining an exemplary embodiment of the invention, as described later in the context of a bi-directional comb drive. MEMS unidirectional comb drive 100 may comprise a shuttle 105, the movable portion, and a stator 110, the anchor portion. Shuttle 105 may include a spring 115 comprising a horizontal bar 120 and a vertical bar 125. Shuttle 105 and stator 110 may be anchored at anchors 130A and 130B, respectively. MEMS unidirectional comb drive 100 may include a set of interdigitated fingers for selectively positioning shuttle 105 responsive to an appropriate actuation force. The actuation force may cause a controlled displacement of shuttle 105 relative to stator 110. Such displacement enables a selective orientation of MEMS unidirectional comb drive 100 at a desired position, which may be generally determined by the amount of displacement, in response to the actuation. Spring 115 could be devised of a desired geometry to generally provide a particular range of displacement responsive to a specific type of actuation force such as an electrostatic force. For example, a voltage bias may be applied between shuttle 105 and stator 110.

In the illustrated exemplary embodiment of FIG. 1A, shuttle 105 having a shuttle anchor side 132 comprises a first set of fingers 135A through 135D. Likewise, stator 110 having a stator anchor side 137 comprises a second set of fingers 140A through 140C. Both the first and second set of fingers 135A through 135D and 140A through 140C are advantageously configured in an interlocked manner. Spring 115 may be coupled between shuttle anchor side 132 and anchor 130A. More specifically, horizontal bar 120 may be fixedly coupled to shuttle anchor side 132 and vertical bar 125 may be fixedly connected to anchor 130A. For stator 110, stator anchor side 137 may be adapted to fixedly connect to anchor 130B.

In operation, MEMS unidirectional comb drive 100 may be selectively displaced responsive to an actuation being applied in the form of an electrostatic force. With continuing reference to FIG. 1A, MEMS unidirectional comb drive 100 could be actuated to move in a x-direction as indicated by a horizontal arrow 142. More specifically, when a voltage bias is applied between the moving part (shuttle 105) and the anchor part (stator 110), the electrostatic force generated from the applied voltage bias will drive the comb drive 100 to move in the x-direction. The amount of displacement is generally determined by balancing the electrostatic force and spring reaction force according the relationship as shown below in equation 1.

$$F = - \frac{\partial U}{\partial x} = \frac{N ϵ {tV}^{2}}{2 d} = kx \qquad ( 1 )$$

Where: V is the applied voltage bias, x the shuttle displacement, N the number of fingers, k the stiffness of the spring(s), ε the air permittivity, and d the gap of fingers (as shown in FIG. 1A).

Two significant aspects are to be noted here. First, the comb drive displacement is independent of the interlocked length (shown in the FIG. 1A as “1−x”) between two combs. This is due to the fact that the electrostatic potential is linearly proportional to the interlocked length, and the force is the derived gradient of the potential, which becomes constant. Second, the displacement is inversely proportional to the stiffness “k” of the springs. In the present case, the spring is made of a long vertical and short horizontal bar. When the comb moves in x-direction, both bars will contribute to the displacement. The percentage of their contribution will, however, be quite different. It is observed that the vertical bar undergoes bending and the horizontal bar the extension. To understand the relative significance of bending and extension, we consider two bars of the same length with a spring bar cross-section of 4×4 micron, driven by 100 V bias on a comb drive of 20 fingers with the finger gap of 4 micron.

Unfortunately, in a two-dimensional comb drive it is even more difficult to avoid deformation and movement of a first set of comb drives while actuating and displacing a second set of comb drives connected to the first set of comb drives. For instance, while performing excursions using the first set of comb drives, in one direction such as the x-axis, it is highly desirable to prevent any displacement along that same axis of the second set of comb drives which may control the motion in the y-axis. Such robust MEMS actuators could operate as a building block in a variety of opto-electromechanical equipment.

Accordingly, there is a need for two-dimensional micro-electromechanical systems (MEMS) comb drive actuator, which may be controllably oriented at a desired position.

### SUMMARY OF THE INVENTION

The present invention generally provides micro-electromechanical systems (MEMS) structures, in particular, MEMS actuators such as comb drives. In an exemplary embodiment, a comb drive apparatus includes a first set of comb pairs and a second set of comb pairs coupled to the first set of comb pairs. A stage may be coupled to the first and second sets of comb pairs. A first plurality of springs may be interposed between the second set of comb pairs and the stage and between the second set of comb pairs and the first set of comb pairs for movably coupling the second set of comb pairs to the stage and to the first set of comb pairs. Likewise, a second plurality of springs may be interposed between the first set of comb pairs and the stage and between the first set of comb pairs and the second set of comb pairs for movably coupling the first set of comb pairs to the stage and to the second set of comb pairs.

The stage may be suspended, electrically conductive, and mechanically operable to permit a controlled displacement thereof in first and second directions responsive to respective first and second actuating forces such as electrostatic forces of appropriate bias. The first actuation force to the first set of comb pairs may provide a first displacement to the stage in the first direction, and the second actuation force to the second set of comb pairs may provide a second displacement to the stage in the second direction. The first actuation force may cause a bending of the first plurality of springs while the second plurality of springs being maintained substantially straight to provide the first displacement. The second actuation force may cause a bending of the second plurality of springs while the first plurality of springs being maintained substantially straight to provide the second displacement.

Each spring of the first plurality of springs may be disposed in a first orientation and each spring of the second plurality of springs may be disposed in a second orientation being substantially orthogonal to the first orientation. In addition, each spring of the first and second pluralities of springs could be formed as a bar.

In an another embodiment, a comb drive apparatus includes a first set of comb pairs, a second set of comb pairs coupled to the first set of comb pairs, and a suspended stage coupled to the first and second sets of comb pairs. Each comb pair of the first set of comb pairs having a first fixed comb and a first movable comb. The first movable comb may include first and second ends being connected by a first support. Each comb pair of the second set of comb pairs having a second fixed comb and a second movable comb. The second movable comb may include first and second ends being connected by a second support.

Each first spring of the first and second pluralities of first springs having a first end and a second end. The first ends of the first plurality of first springs being connected to the suspended stage and the second ends of the first plurality of first springs being connected to the respective second support of the second movable combs. And the first ends of the second plurality of first springs being connected to the respective first movable comb and the second ends of the second plurality of first springs being connected to the respective first end or second end of the second movable combs, thereby movably coupling the second set of comb pairs to the suspended stage and to the first set of comb pairs.

Each second spring of the first and second pluralities of second springs having a first end and a second end. The first ends of the first plurality of second springs being connected to the suspended stage and the second ends of the first plurality of second springs being connected to the respective first support of the first movable combs. And the first ends of the second plurality of second springs being connected to the respective second movable comb and the second ends of the second plurality of second springs being connected to the respective first end or second end of the first movable combs, thereby movably coupling the first set of comb pairs to the suspended stage and to the second set of comb pairs.

In operation, said first set of comb pairs may provide a first displacement to the suspended stage in a first direction in response to a first electrostatic force. The second set of comb pairs may provide a second displacement to the suspended stage in a second direction in response to a second electrostatic force. The first electrostatic force may cause a controlled bending of the first and second pluralities of first springs for displacing the first movable combs while the first and second pluralities of second springs being maintained substantially straight for preventing displacement of the second movable combs. The second electrostatic force may cause a controlled bending of the first and second pluralities of second springs for displacing the second movable combs while the first and second pluralities of first springs being maintained substantially straight for preventing displacement of the first movable combs.

In an another alternate exemplary embodiment, a micro-electromechanical apparatus including first, second, third, and fourth comb drives, the first comb drive being disposed spatially opposite to the second comb drive and the third comb drive being disposed spatially opposite to the fourth comb drive, each comb drive including: a fixed comb having a first set of fingers; a movable comb having a first end, second end, support, and a second set of fingers arranged in an interdigitated manner with the first set of fingers; and first, second, and third springs coupled to the movable comb to said first end, said second end, and said support, respectively, wherein the movable comb being suspended by the first, second, and third springs for providing a displacement thereof relative to the fixed comb in response to an actuating force being applied between the fixed comb and the movable comb.

In an another alternate exemplary embodiment, a micro-electromechanical comb drive including first, second, third, and fourth comb drives, the first comb drive being spatially disposed opposite to the second comb drive and the third comb drive being spatially disposed opposite to the fourth comb drive, each comb drive including: a fixed electrode; a movable electrode disposed spatially opposite to the fixed electrode; and a plurality of spring bars coupled to the movable electrode, the plurality of spring bars being selectively oriented responsive to an actuating force being applied between the fixed and movable electrodes.

In an another alternate exemplary embodiment, a micro-electromechanical actuator including first, second, third, and fourth drives, the first drive being spatially disposed opposite to the second drive and the third drive being spatially disposed opposite to the fourth drive, each drive including: a fixed portion a movable portion; and a spring structure formed to suspend the movable portion, the spring structure displaces the movable portion relative to the fixed portion in response to an actuating force being applied between the fixed portion and the movable portion.

In an another alternate exemplary embodiment, a two-dimensional comb drive apparatus including a set of horizontal comb pairs, each of the horizontal comb pair having a horizontal fixed comb and a horizontal movable comb, the horizontal movable comb including first and second ends being connected by a horizontal support; a set of vertical comb pairs coupled to the set of horizontal comb pairs, each of the vertical comb pair having a vertical fixed comb and a vertical movable comb, the vertical movable comb including first and second ends being connected by a vertical support; a suspended stage coupled to the sets of horizontal and vertical comb pairs; first and second pluralities of horizontal springs, each horizontal spring having a first end and a second end, the first ends of the first plurality of horizontal springs being connected to the suspended stage and the second ends of the first plurality of horizontal springs being connected to the respective vertical support of the vertical movable combs, and the first ends of the second plurality of horizontal springs being connected to the respective horizontal movable comb and the second ends of the second plurality of horizontal springs being connected to the respective first end or second end of the vertical movable combs, thereby movably coupling the set of vertical comb pairs to the suspended stage and to the set of horizontal comb pairs; and first and second pluralities of vertical springs, each vertical spring having a first end and a second end, the first ends of the first plurality of vertical springs being connected to the suspended stage and the second ends of the first plurality of vertical springs being connected to the respective horizontal support of the horizontal movable combs, and the first ends of the second plurality of vertical springs being connected to the respective vertical movable comb and the second ends of the second plurality of vertical springs being connected to the respective first end or second end of the horizontal movable combs, thereby movably coupling the set of horizontal comb pairs to the suspended stage and to the set of vertical comb pairs.

In an another alternate exemplary embodiment, a method for forming a two-dimensional comb drive, comprising: providing a first set of comb pairs; providing a second set of comb pairs coupled to the first set of comb pairs; providing a stage coupled to the sets of first and second comb pairs; providing a first plurality of springs interposed between the second set of comb pairs and the stage and between the second set of comb pairs and the first set of comb pairs for movably coupling the second set of comb pairs to the stage and to the first set of comb pairs; and providing a second plurality of springs interposed between the first set of comb pairs and the stage and between the first set of comb pairs and the second set of comb pairs for movably coupling the first set of comb pairs to the stage and to the second set of comb pairs.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention and the advantages thereof, reference is now made to the following descriptions taken in conjunction with the accompanying drawings, in which:

FIG. 1A is a top plan view of a prior art micro-electromechanical systems (MEMS) unidirectional comb drive.

FIG. 1B is a graph of exemplary displacements due to bending and extension for a MEMS comb drive.

FIG. 2A is a top plan view of an exemplary embodiment of a MEMS fully suspended bi-directional comb drive consistent with one aspect the present invention.

FIG. 2B is a top plan view of the MEMS fully suspended bi-directional comb drive of FIG. 2A actuated in x-axis (horizontal direction) in accordance with one aspect of the present invention.

FIG. 3 is a graph of an exemplary variation of displacements for the MEMS fully suspended bi-directional comb drive of FIG. 4A with different spring lengths.

FIG. 4A is a top plan view of an exemplary MEMS inter-linked bi-directional comb drive.

FIG. 4B is a top plan view of an exemplary MEMS nested bi-directional comb drive.

FIG. 5 is a top plan view of an exemplary embodiment of a MEMS fully suspended bi-directional comb drive actuator for optical applications consistent with one aspect the present invention.

FIG. 6A is a top plan view of the MEMS fully suspended bi-directional comb drive actuator of FIG. 5 actuated in x-axis (horizontal direction).

FIG. 6B is a top plan view of the MEMS fully suspended bi-directional comb drive actuator of FIG. 5 actuated concurrently in x-axis (horizontal direction) and y-axis (vertical direction).

FIG. 7A is a top plan view of another exemplary embodiment of a MEMS fully suspended bi-directional comb drive actuator for optical applications in accordance with one aspect the present invention.

FIG. 7B is a top plan view of the MEMS fully suspended bi-directional comb drive actuator of FIG. 7A actuated in y-axis (vertical direction).

### DETAILED DESCRIPTION

A Micro-electromechanical systems (MEMS) actuator such as a MEMS comb drive generally comprises comb pairs, each comb pair may include a fixed comb and a movable comb coupled to a plurality of suspension members, such as springs bars, or the like. Suspension members are generally utilized to support the movable combs. Suspension members may be suitably devised to enable a controlled operation of the MEMS comb drive. An actuation force such as an electrostatic force may be selectively applied to the comb pairs for orienting the MEMS comb drive at a desired position. The present invention is generally directed to such MEMS comb drives, which could be utilized for realizing a variety of control and/or communication systems.

One exemplary embodiment of the present invention is generally described with respect to a MEMS fully suspended bi-directional comb drive, which includes suspension members as spring bars. The geometric features for the spring bars can be readily devised using a conventional photolithography based micro-fabrication process. In an exemplary embodiment, a suitable micro-fabrication technology, in a known manner, is generally employed to fabricate the chip-scale or miniature device of the present invention useful for a variety of optical applications. For example, an optical MEMS actuator may be advantageously devised to integrate with one or more micro-optical elements such as micro-lenses or micro-mirrors. The present invention should, however, not necessarily be restricted to the field of micro-optical elements and/or comb drive actuators, as will be readily evident. Like reference numerals refer to similar elements throughout the drawings.

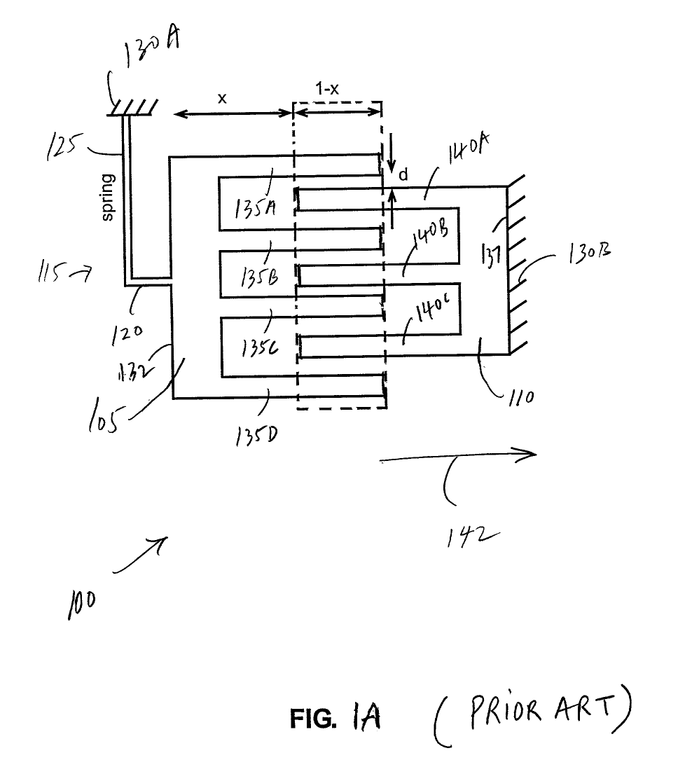

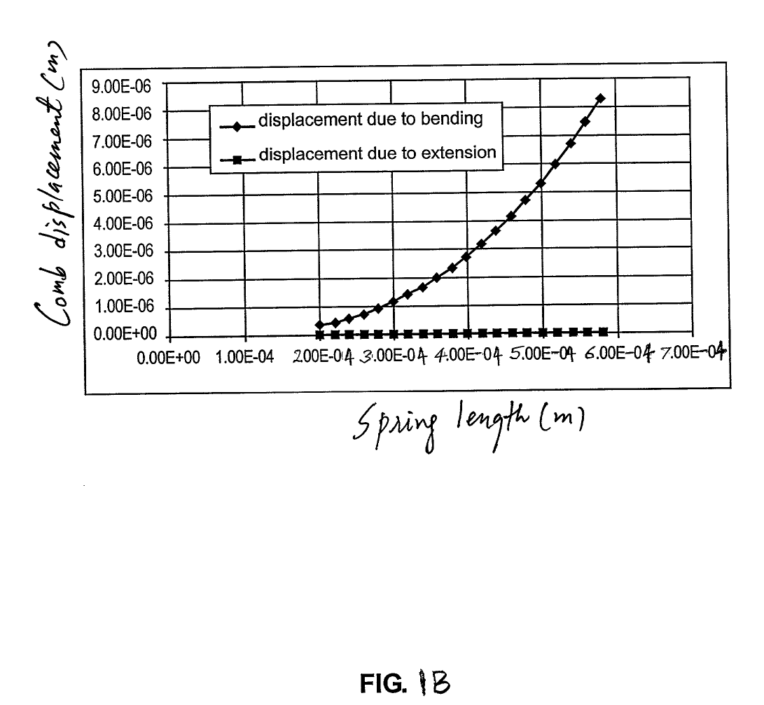

FIG. 1B is a graph of exemplary displacements (in meters) due to bending and extension for a MEMS comb drive such as the MEMS unidirectional comb drive 100 of FIG. 1A. It is observed that the displacement due to bending is an order or two magnitudes larger than the displacement due to the extension. In fact, the displacement due to the extension can be practically neglected. This observation bears significant implications for bi-directional or two-dimensional comb drives.

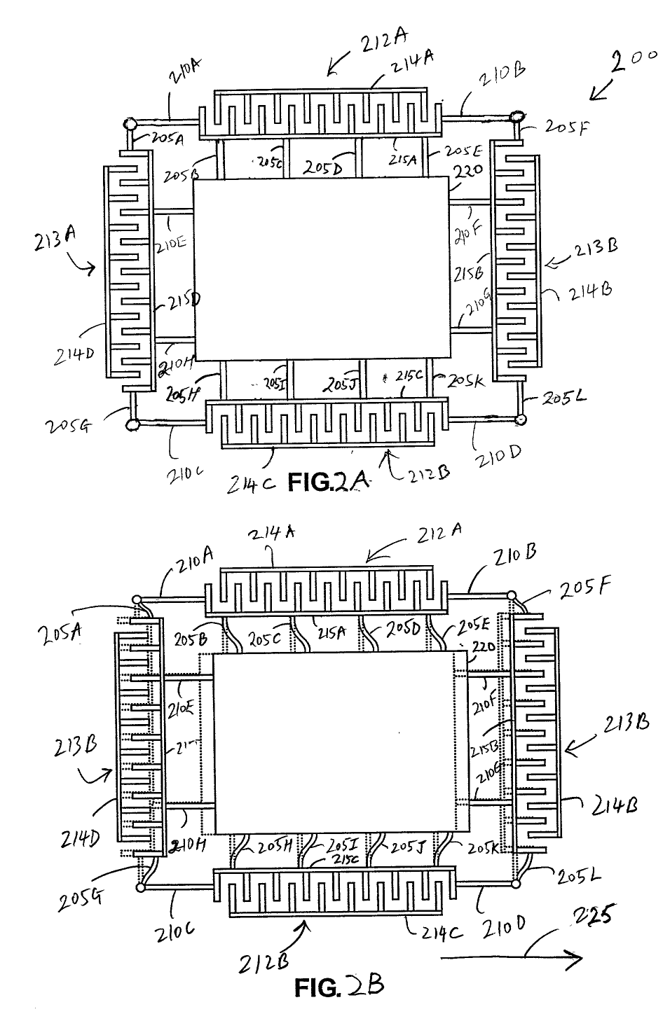

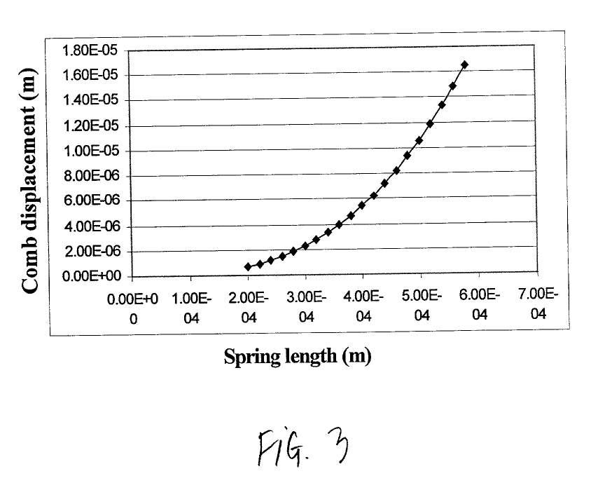

FIG. 2A is a top plan view of an exemplary embodiment of a MEMS fully suspended bi-directional comb drive 200 consistent with one aspect the present invention. A relatively simple but representative design of MEMS fully suspended bi-directional comb drive 200 may comprise vertical spring bars 205A through 205L and horizontal spring bars 210A through 210H to fully suspend a movable portion without touching a fixed portion. The MEMS fully suspended bi-directional comb drive 200 may further comprise a first set of horizontal combs 212A, 212B and a second set of vertical combs 213A, 213B. Each of the first set of horizontal combs 212A, 212B includes a pair of oppositely disposed combs with one comb being movable and the other being fixed. In particular, the horizontal comb 212A includes a fixed comb 214A and a movable comb 215A.

The fixed portion may include fixed combs 214A through 214D. Likewise, the movable portion may include movable combs 215A through 215D and an inter-linked stage 220. Each movable comb 215 is generally attached by both associated horizontal and vertical spring bars. For example, movable comb 215A is attached to horizontal spring bars 210A, 210B and vertical spring bars 205B through 205E. This pattern of spring distribution is advantageously employed to exploit the bending versus extension behavior as illustrated in FIG. 1B to achieve relatively large bi-directional movement without being limited by finger spacing.

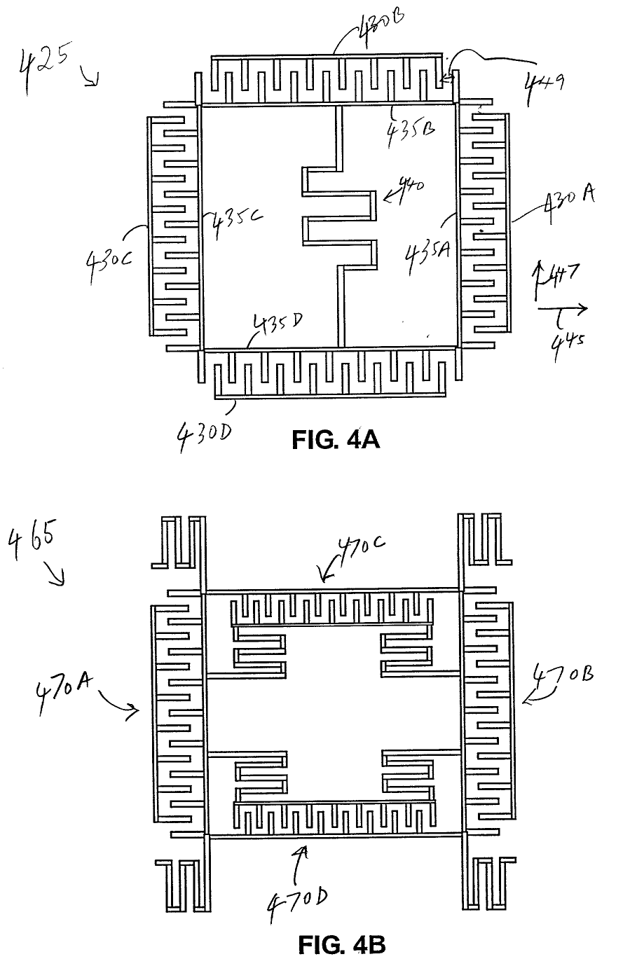

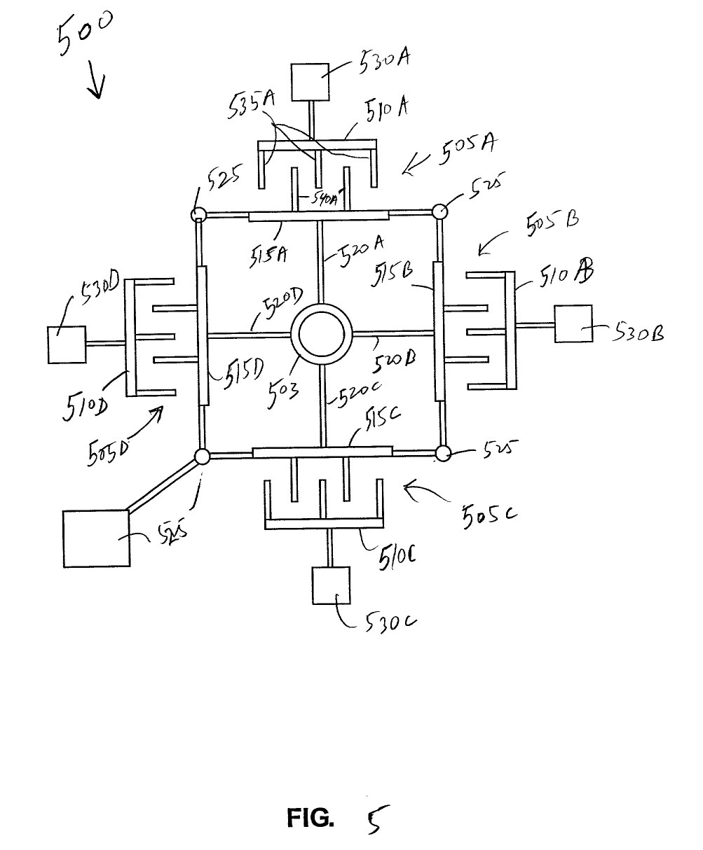

FIG. 2B is a top plan view of the MEMS fully suspended bi-directional comb drive 200 of FIG. 2A actuated in x-axis (horizontal direction 225). Thus, when the left and right combs are actuated in x-direction, the horizontal displacement will make all vertical spring bars 205A through 205L bend by approximately the same amount, but the horizontal spring bars 210A through 210H assume very little deformation since bending is the dominating deformation as opposed to extension. Therefore, the movement in top and bottom combs 215A and 215C, respectively, can be negligible (as indicated from the deformed shape in FIG. 4B). Accordingly, the movement in horizontal direction 225 is not going to cause vertical comb fingers to touch each other. Similarly, actuation in the vertical direction is not going to cause horizontal comb finger interference. Thus, MEMS fully suspended bi-directional comb drive 200 can achieve large x and y displacements without being limited by comb finger spacing. Moreover, MEMS fully suspended bi-directional comb drive 200 has a decent form factor, enough real estate for center mass distribution, and equal participating mass in x- and y-direction actuation. It shores the advantages of both inter-linked and nested comb drives.

As persons skilled in the art will appreciate that using a typical micro-fabrication process, in a known manner, the MEMS fully suspended bi-directional comb drive 200 may be readily fabricated. For example, employing a substrate layer and a conductive layer, the MEMS fully suspended bi-directional comb drive 200 may be formed through a deposition and patterning process. In particular, the first set of horizontal combs 212A, 212B, second set of vertical combs 213A, 213B, inter-linked stage 220, and vertical spring bars 205A through 205L and horizontal spring bars 210A through 210H may be formed from a single layer. For example, a layer of polysilicon may be utilized to form the MEMS fully suspended bi-directional comb drive 200. Additionally, the vertical spring bars 205A through 205L and horizontal spring bars 210A through 210H could be suitably attached to the substrate layer to form anchors. For example, vias may be devised for anchoring the MEMS fully suspended bi-directional comb drive 200.

However, it is to be understood that the movable combs 215A through 215D of the MEMS fully suspended bi-directional comb drive 200 may or may not share the same anchors at the four comers of the structure as depicted in FIGS. 2A and 2B. For example, the vertical spring bar 205A and the horizontal spring bar 210A could be anchored separately.

In an exemplary embodiment, one-micron thick layer of polysilicon may be used as the primary composition of the single conductive layer. However, other materials or combinations of materials may be employed, which can be deposited and patterned according to a desired specification over a particular substrate layer.

In operation, a two-dimensional comb drive such as the MEMS filly suspended bi-directional comb drive 200 may be controllably oriented at a desired position responsive to an appropriate actuation. Specifically, undesired deformation and movement of the second set of vertical combs 213A, 213B while actuating and displacing the first set of horizontal combs 212A, 212B coupled to the second set of vertical combs 213A, 213B can be significantly reduced by appropriate shapes, positions, and combinations thereof for the vertical spring bars 205A through 205L and horizontal spring bars 210A through 210H. Likewise, undesired deformation and movement of the first set of horizontal combs 212A, 212B while actuating and displacing the second set of vertical combs 213A, 213B coupled to the first set of horizontal combs 212A, 212B can also be significantly reduced. For instance, while performing excursions using the second set of vertical combs 213A, 213B, in one direction such as the x-axis, selective bending of the vertical spring bars 205A through 205L and stiffness of the horizontal spring bars 210A through 210H may prevent substantial displacement along that same axis of the movable combs 215A through 215D of the first set of horizontal combs 212A, 212B which may control the motion in the y-axis.

FIG. 3 is a graph of a range of exemplary displacements calculated for the MEMS fully suspended bi-directional comb drive 200 of FIG. 2A for different spring bar lengths. It is to be understood that as shown in FIG. 2A just straight bars may function as springs. Moreover, the MEMS fully suspended bi-directional comb drive 200 can be readily devised to provide maximum displacements in x or y directions through parametric optimization of spring pattern and spring distribution.

In an exemplary embodiment, MEMS fully suspended bi-directional comb drive 200 comprises a conductor or semi-conductor, with each pair of opposing combs having 20 to 19 interdigitated fingers. The spring bar cross-section is 3×4 microns, i.e. 3 microns thickness and 4 microns width, and the fingers are 8 microns long with a gap between fingers of 2 microns. As an example, the length of vertical spring bars 205A through 205L is devised twice the length of horizontal spring bars 210A through 210H. As shown in FIG. 3, displacements greater than 10 microns are attainable for spring bar lengths greater than 500 microns. Persons skilled in the art will recognize that such geometric features are readily achievable using generally known photolithography based micro-fabrication manufacturing processes. The foregoing describes only one embodiment of the invention and many variations of the embodiment will be obvious for a person skilled in the art of semiconductor, micro-electromechanical fabrication. Certainly, various other materials and techniques can be utilized in the construction of the various layers.

FIG. 4A is a top plan view of an exemplary MEMS inter-linked bi-directional comb drive 425. In this configuration, four exterior combs 430A through 430D (two horizontal and two vertical) are anchored, and four internal combs 435A through 435D are inter-linked via an inter-link 440. A desired movement or displacement of the inter-linked combs in x-direction as indicated by an arrow 445, can be achieved by applying an appropriate voltage between the two exterior horizontal combs 430A and 430C and the inter-linked internal combs 435A through 435D. Likewise, in y-direction as indicated by an arrow 447, a movement can be achieved by applying a suitable voltage between the two exterior vertical combs 430B and 430D and the inter-linked internal combs 435A through 435D. Among many advantages, the main advantages of the inter-linked comb drives are decent form factor (x-y dimensions can be the same), and achievable equal or similar electrostatic driving force. However, both x- and y-directional movements can be limited by a finger gap 449 (assuming all exterior and internal combs are identical in shape and size). For example, when the amount of displacement in the x-direction 445 exceeds the finger gap 449, the vertical fingers of the anchored combs 430B and 430D and movable combs 435B and 435D will touch each other, creating an electrical short. This factor could become even more exacerbated in applications where the finger gap 449 has to be small to obtain enough driving force.

FIG. 4B is a top plan view of an exemplary MEMS nested bi-directional comb drive 465. MEMS nested bi-directional comb drive 465 may include horizontal or external combs 470A, 470B and vertical or nested combs 470C and 470D. With reference to FIGS. 4A and 4B, a desired movement in the x-direction 445 can be achieved by appropriately driving horizontal combs 470A, 470B. Likewise, a movement in y-direction 447 may be achieved by suitably driving the vertical combs 470C and 470D, which are rigidly nested within the movable-part frame of horizontal combs 470A, 470B. When an external comb drive is in action and a movement in the x-direction 445 is actuated, the movable and fixed parts of the nested combs 470C and 470D moves the same amount. On the other hand, when the nested combs 470C and 470D are in action and a vertical displacement in the y-direction 447 is actuated, the external combs 470A and 470B are fully anchored. Therefore, this design may completely eliminate the x-y motion interference. Accordingly, the displacement may not be limited by finger gap.

However, nested spring and combs generally occupy the internal spaces and reduce the real estate and flexibility for mass distribution. In addition, to achieve the same actuation force, the nested combs 470C and 470D may have to assume a geometry (e.g. comb spacing, finger size) different from the external combs 470A and 470B, thereby increasing process complexity. Moreover, the actuation mass in the x-direction 445 is different from that in the y-direction 447, as the movement in the x-direction 445 carries the complete nested combs 470C and 470D, but the movement in y-direction 447 only moves the external combs 470A and 470B.

FIG. 5 is a top plan view of an exemplary embodiment of a MEMS fully suspended bi-directional actuator 500 consistent with one aspect of the present invention. The MEMS fully suspended bi-directional actuator 500 may comprise a micro-frame 503 to receive a micro-optical element such as a micro-lens or a micro-mirror and comb drives 505A through 505D. Each comb drive includes a fixed comb configured in interdigitated fashion with an associated movable drive. For example, comb drives 505A through 505D each comprise a fixed comb 510, 510A through 510D, and an associated movable comb 515, 515A through 515D, respectively. In shown embodiment of FIG. 5, the comb drives 505A through 505D are identical. However, different sizes, shapes or forms of comb drives 505A through 505D could be devised. Moreover, micro-frame 503 may be devised to connect with movable combs 515A through 515B via spring bars 520A through 520D.

Each movable comb, 515A through 515D may include first and second ends extended longitudinally for fixedly connecting the movable comb to a substrate 525, thereby suspending the MEMS fully suspended bi-directional actuator 500. To couple fixed combs 510A through 510D to the substrate 525, anchors 530A through 530D, respectively, may be utilized. However, it should be appreciated that fixed combs 510A through 510D may be coupled differently to the substrate 525. Each comb drive 505 may include a set of interdigitized fingers. More specifically, each fixed and movable combs 510, 515 may comprise a plurality of fingers to form the set of interdigitized fingers. For example, fixed comb 510A may include a first set of fingers 535A and movable comb 515A may include a second set of fingers 540A. As shown in FIG. 5, the first set of fingers 535A could include nineteen fingers with each finger having 10 microns of width and generally interposed at 8 microns in separation from the adjacent finger. Moreover, fingers may comprise a metal layer.

It is to be understood that the MEMS fully suspended bi-directional actuator 500 may be fabricated with MEMS technology generally utilizing a known surface micro-machining manufacturing process. The depicted actuator 500 could be advantageously utilized for a variety of optical applications. For example, micro-optics can be readily integrated with the actuator 500 to enable optical communications. In one embodiment, a micro-lens may be disposed in the micro-frame 503 for manipulating any optical signals projected therethrough.

In operation, MEMS fully suspended bi-directional actuator 500 may selectively micro-position the micro-lens in response to an actuating force such as an electrostatic force being applied through an actuation voltage. When an appropriate actuation voltage is placed across either the first and second set of fingers 535A, 540A, an electrostatic charge may be generated therebetween. In turn, movable comb 515A may be displaced. For example, when the comb drive 505A may be actuated, first movable comb 515A may be pulled towards the associated fixed comb 510A. In one embodiment, actuation voltage of 50 Volts is used for providing a maximum displacement of 5 microns.

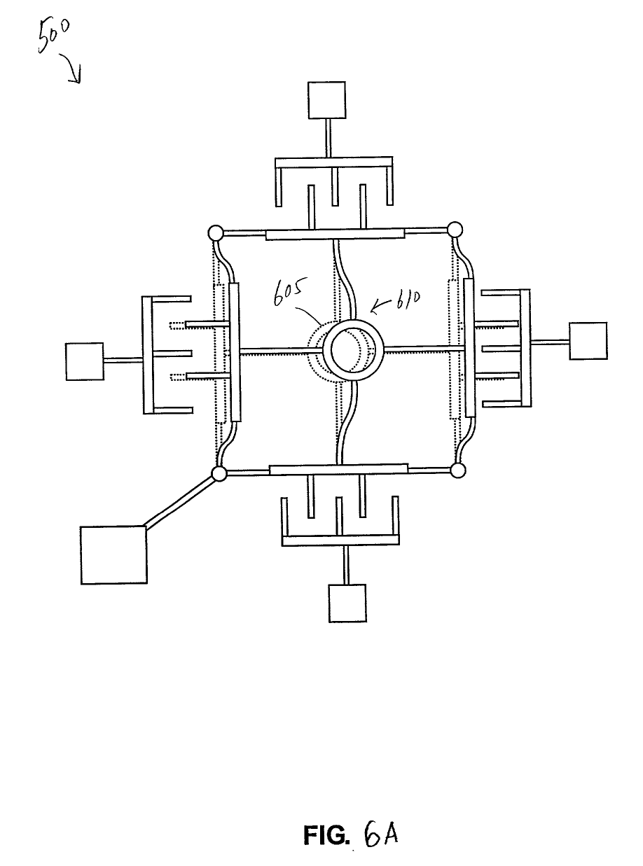

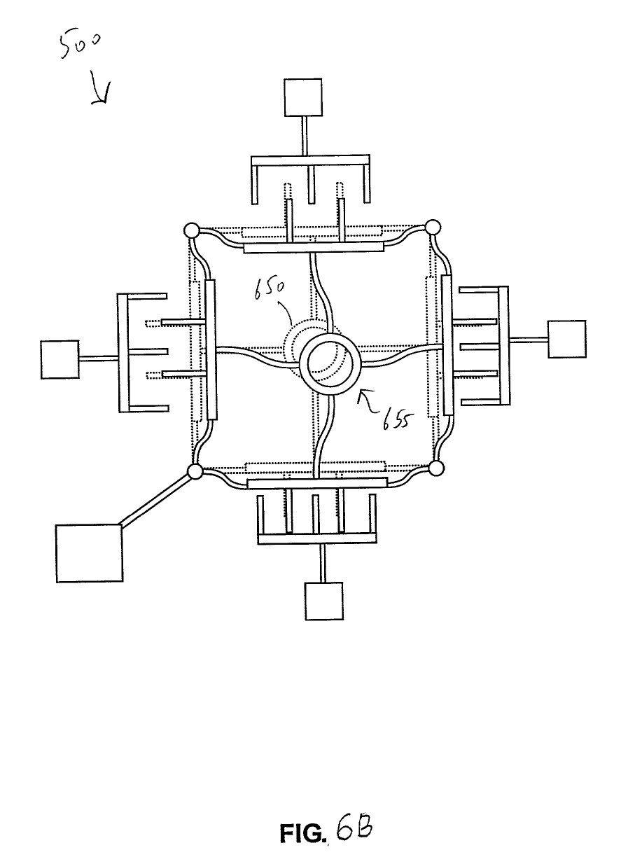

FIG. 6A is a top plan view of the MEMS fully suspended bi-directional comb drive actuator 500 of FIG. 5 actuated in x-axis (horizontal direction). A pre-actuated position of the actuator 500 is indicated by a dotted structure 605. Upon proper actuation, a portion of the MEMS fully suspended bi-directional comb drive actuator 500 is displaced. A post-actuated position of the actuator 500 is illustrated by a stretched structure 610.

FIG. 6B is a top plan view of the MEMS fully suspended bi-directional comb drive actuator 500 of FIG. 5 actuated concurrently in x-axis (horizontal direction) and y-axis (vertical direction). A pre-actuated position of the actuator 500 is depicted by a dotted structure 650. When appropriately actuated, a portion of the MEMS fully suspended bi-directional comb drive actuator 500 is displaced. Accordingly, a post-actuated position of the actuator 500 is illustrated by a moved structure 655. With reference to FIGS. 6A and 6B, displacements of more than 10 microns may be readily attainable. It should be appreciated that significantly larger displacements could be achieved with finer geometric features, even at a reduced spring length.

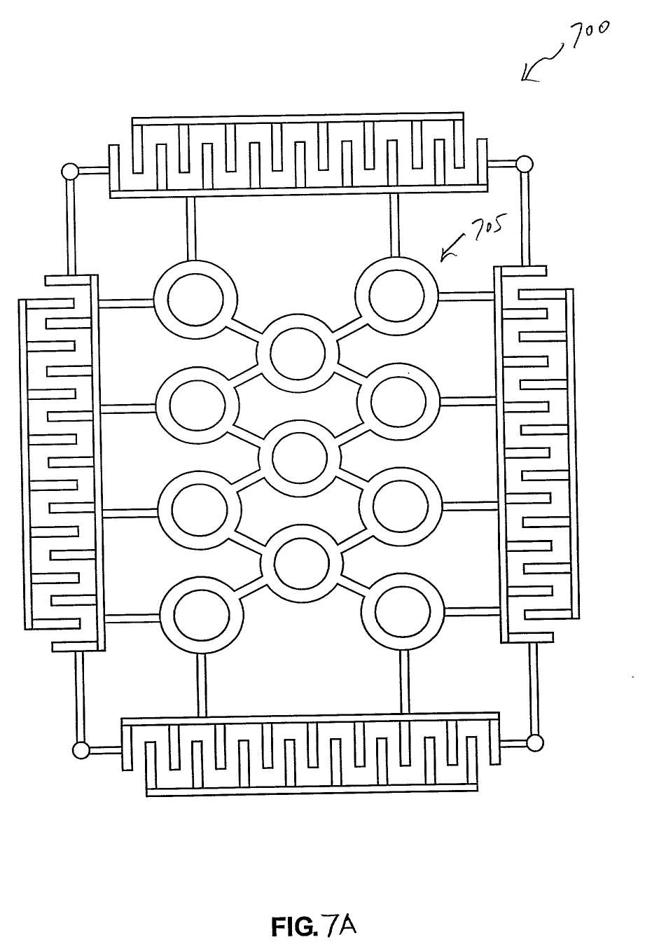

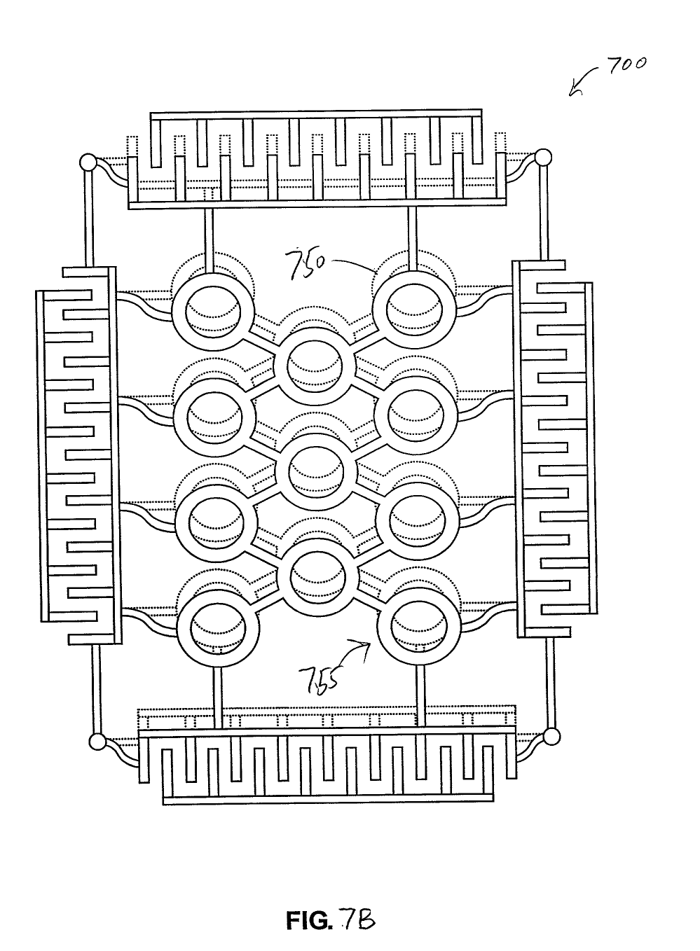

FIG. 7A is a top plan view of another exemplary embodiment of a MEMS fully suspended bi-directional comb drive actuator 700 for optical applications in accordance with one aspect the present invention. MEMS fully suspended bi-directional comb drive actuator 700 may include an array of micro-frames 705. FIG. 7B is a top plan view of the MEMS fully suspended bi-directional comb drive actuator 700 of FIG. 7A actuated in y-axis (vertical direction). A pre-actuated position of the actuator 700 is indicated by a dotted structure 750. Upon proper actuation, a portion of the MEMS fully suspended bi-directional comb drive actuator 700 is displaced. A post-actuated position of the actuator 700 is illustrated by a stretched structure 755.

Accordingly, an apparatus and method for a micro-electromechanical systems (MEMS) actuator such as a MEMS two-dimensional electrostatic comb drive having springs being advantageously configured to provide relatively large movements in first and second directions is generally disclosed. In response to an appropriate electrostatic actuation force being applied to the MEMS two-dimensional electrostatic comb drive, the springs enable controlled displacement along both x-axis (horizontal direction) and y-axis (vertical direction).

Although the present invention and its advantages have been described in detail, it should be understood that various changes, substitutions and alterations can be made to the embodiments herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim:

1. A comb drive apparatus, comprising:
a first set of comb pairs;
a second set of comb pairs coupled to the first set of comb pairs;
a stage coupled to the first and second sets of comb pairs;
a first plurality of springs interposed between the second set of comb pairs and the stage and between the second set of comb pairs and the first set of comb pairs for movably coupling the second set of comb pairs to the stage and to the first set of comb pairs; and
a second plurality of springs interposed between the first set of comb pairs and the stage and between the first set of comb pairs and the second set of comb pairs for movably coupling the first set of comb pairs to the stage and to the second set of comb pairs.

2. The apparatus of claim 1, wherein each spring of said first plurality of springs being disposed in a first orientation and each spring of said second plurality of springs being disposed in a second orientation substantially orthogonal to the first orientation.

3. The apparatus of claim 2, wherein each spring of said first and second pluralities of the springs is a bar.

4. The apparatus of claim 1, wherein said each comb pair of the first set of comb pairs comprising:
a first fixed comb; and
a first movable comb being disposed spatially opposite to the first fixed comb.

5. The apparatus of claim 1, wherein said each comb pair of the second set of comb pairs comprising:
a second fixed comb; and
a second movable comb being disposed spatially opposite to the second fixed comb.

6. The apparatus of claim 1, wherein a first actuation force to said first set of comb pairs providing a first displacement to the stage in a first direction, and a second actuation force to said second set of comb pairs providing a second displacement to the stage in a second direction.

7. The apparatus of claim 6, wherein said first actuation force causes a bending of the first plurality of springs while the second plurality of springs being maintained substantially straight to provide said first displacement.

8. The apparatus of claim 6, wherein said second actuation force causes a bending of the second plurality of springs while the first plurality of springs being maintained substantially straight to provide said second displacement.

9. A comb drive apparatus, comprising:
a first set of comb pairs, each said comb pair having a first fixed comb and a first movable comb, the first movable comb including first and second ends being connected by a first support;
a second set of comb pairs coupled to the first set of comb pairs, each said comb pair of the second set of comb pairs having a second fixed comb and a second movable comb, the second movable comb including first and second ends being connected by a second support;
a suspended stage coupled to the first and second sets of comb pairs;
first and second pluralities of first springs, each first spring having a first end and a second end, the first ends of the first plurality of first springs being connected to the suspended stage and the second ends of the first plurality of first springs being connected to the respective second support of the second movable combs, and the first ends of the second plurality of first springs being connected to the respective first movable comb and the second ends of the second plurality of first springs being connected to the respective first end or second end of the second movable combs, thereby movably coupling the second set of comb pairs to the suspended stage and to the first set of comb pairs; and
first and second pluralities of second springs, each second spring having a first end and a second end, the first ends of the first plurality of second springs being connected to the suspended stage and the second ends of the first plurality of second springs being connected to the respective first support of the first movable combs, and the first ends of the second plurality of second springs being connected to the respective second movable comb and the second ends of the second plurality of second springs being connected to the respective first end or second end of the first movable combs, thereby movably coupling the first set of comb pairs to the suspended stage and to the second set of comb pairs.

10. The apparatus of claim 9, wherein each first and second spring of said first and second pluralities of the first and second springs is a bar.

11. The apparatus of claim 9, wherein said first fixed comb being disposed spatially opposite to said first movable comb.

12. The apparatus of claim 9, wherein said second fixed comb being disposed spatially opposite to said second movable comb.

13. The apparatus of claim 9, wherein said first set of comb pairs providing a first displacement to the suspended stage in a first direction in response to a first electrostatic force, and said second set of comb pairs providing a second displacement to the suspended stage in a second direction in response to a second electrostatic force.

14. The apparatus of claim 13, wherein said first electrostatic force causes a controlled bending of the first and second pluralities of first springs for displacing said first movable combs while the first and second pluralities of second springs being maintained substantially straight for preventing displacement of said second movable combs.

15. The apparatus of claim 13, wherein said second electrostatic force causes a controlled bending of the first and second pluralities of second springs for displacing said second movable combs while the first and second pluralities of first springs being maintained substantially straight for preventing displacement of said first movable combs.

16. A method for forming a two-dimensional comb drive, comprising:
providing a first set of comb pairs;
providing a second set of comb pairs coupled to the first set of comb pairs;
providing a stage coupled to the sets of first and second comb pairs;
providing a first plurality of springs interposed between the second set of comb pairs and the stage and between the second set of comb pairs and the first set of comb pairs for movably coupling the second set of comb pairs to the stage and to the first set of comb pairs; and
providing a second plurality of springs interposed between the first set of comb pairs and the stage and between the first set of comb pairs and the second set of comb pairs for movably coupling the first set of comb pairs to the stage and to the second set of comb pairs.

17. A micro-electromechanical apparatus, comprising:
first, second, third, and fourth comb drives, the first comb drive being disposed spatially opposite to the second comb drive and the third comb drive being disposed spatially opposite to the fourth comb drive, each comb drive including:
a fixed comb having a first set of fingers;
a movable comb having a first end, second end, support, and a second set of fingers arranged in an interdigitated manner with the first set of fingers; and
first, second, and third springs coupled to the movable comb to said first end, said second end, and said support, respectively, wherein the movable comb being suspended by the first, second, and third springs for providing a displacement thereof relative to the fixed comb in response to an actuating force being applied between the fixed comb and the movable comb.

18. A micro-electromechanical comb drive, comprising:
first, second, third, and fourth comb drives, the first comb drive being spatially disposed opposite to the second comb drive and the third comb drive being spatially disposed opposite to the fourth comb drive, each comb drive including:
a fixed electrode;
a movable electrode disposed spatially opposite to the fixed electrode; and
a plurality of spring bars coupled to the movable electrode, the plurality of spring bars being selectively oriented responsive to an actuating force being applied between the fixed and movable electrodes.

19. A micro-electromechanical actuator, comprising:
first, second, third, and fourth drives, the first drive being spatially disposed opposite to the second drive and the third drive being spatially disposed opposite to the fourth drive, each drive including:
a fixed portion a movable portion; and
a spring structure formed to suspend the movable portion, the spring structure displaces the movable portion relative to the fixed portion in response to an actuating force being applied between the fixed portion and the movable portion.

20. A two-dimensional comb drive apparatus, comprising:
a set of horizontal comb pairs, each of the horizontal comb pair having a horizontal fixed comb and a horizontal movable comb, the horizontal movable comb including first and second ends being connected by a horizontal support;
a set of vertical comb pairs coupled to the set of horizontal comb pairs, each of the vertical comb pair having a vertical fixed comb and a vertical movable comb, the vertical movable comb including first and second ends being connected by a vertical support;
a suspended stage coupled to the sets of horizontal and vertical comb pairs;
first and second pluralities of horizontal springs, each horizontal spring having a first end and a second end, the first ends of the first plurality of horizontal springs being connected to the suspended stage and the second ends of the first plurality of horizontal springs being connected to the respective vertical support of the vertical movable combs, and the first ends of the second plurality of horizontal springs being connected to the respective horizontal movable comb and the second ends of the second plurality of horizontal springs being connected to the respective first end or second end of the vertical movable combs, thereby movably coupling the set of vertical comb pairs to the suspended stage and to the set of horizontal comb pairs; and
first and second pluralities of vertical springs, each vertical spring having a first end and a second end, the first ends of the first plurality of vertical springs being connected to the suspended stage and the second ends of the first plurality of vertical springs being connected to the respective horizontal support of the horizontal movable combs, and the first ends of the second plurality of vertical springs being connected to the respective vertical movable comb and the second ends of the second plurality of vertical springs being connected to the respective first end or second end of the horizontal movable combs, thereby movably coupling the set of horizontal comb pairs to the suspended stage and to the set of vertical comb pairs.
